(19) United States
(12) Patent Application Publication
(10) Pub. No.: US 2025/0162801 A1
(43) Pub. Date: May 22, 2025

(54) STORAGE SYSTEM FOR CONSTRUCTION BOARDS

(71) Applicant: SIEMPELKAMP MASCHINEN-UND ANLAGENBAU GMBH, Krefeld (DE)

(72) Inventors: Michael KREUTER, Krefeld (DE); Martin KRONENBERG, Neuss (DE); Lothar STEINER, Wachtendonk (DE); Michael VAESSEN, Neuss (DE)

(21) Appl. No.: 18/836,581

(22) PCT Filed: Jan. 30, 2023
(86) PCT No.: PCT/EP2023/052193

§ 371 Date: Aug. 7, 2024

(30) Foreign Application Priority Data
Feb. 15, 2022 (DE) 102022000571.9

(51) Int. Cl. B65G 1/04; B65G 1/06

(52) U.S. Cl. CPC B65G 1/0492; B65G 1/065; B65G 2201/022

(57) ABSTRACT

The invention relates to a storage device for material boards (2), having a rail-bound main track (6) and at least one main vehicle (4), which can travel on the main track, and also a plurality of transfer paths (7) that lead to board deposit points (9), and at least one satellite vehicle (5), which can travel on the transfer paths and is able to move at least one material board (2), wherein a holding area (8) is provided on the main vehicle (4) for at least one satellite vehicle (5), wherein the main vehicle (4) has an electrical power supply, for example via a sliding contact, and a drive means comprising a main vehicle electric motor (12), and wherein the satellite vehicle (5) likewise has a drive means comprising a satellite vehicle electric motor (22). In order to make the main vehicle and the satellite vehicle more independent of one another, provision is made for the satellite vehicle electric motor (22) of the satellite vehicle (5) to be able to be supplied with power via an energy store (20) connected to the satellite vehicle (5) and for the energy store (20) to be able to be charged by means of a charging station (17) on the main vehicle (4).

The invention relates to a storage system for construction boards with a rail-type base travel path and at least one base vehicle movable thereon as well as several transfer paths leading to board-storage locations and at least one satellite vehicle movable thereon that is capable of moving at least one construction board, where a home space is provided on the base vehicle for the satellite vehicle, the base vehicle has an electrical power supply, for example via a slide contact, and a drive with a base-vehicle electric motor and the satellite vehicle also has a drive with a satellite-vehicle electric motor.

In the course of manufacturing construction boards, in particular construction boards comprising pressed and glued wood chips or fibers, it is necessary to temporarily store them in a warehouse. This can be the case, for example, if the construction boards have to cool down after hot pressing or if they are to be fed to a further processing step that does not run continuously but intermittently, with periodic interruptions. Such processes are frequently found, for example, in a trimming system, a coating device, a sanding machine or a packaging unit. The material sheets can be placed individually on supports in the warehouse. However, the material sheets are usually stacked in order to take up less storage space. The stacks of material sheets can be between 4 and 5 meters high, so that a stack can weigh up to around 60 tons.

The satellite vehicles are able to move these big stacks and even carry them onto a base vehicle. They only have to move along the transfer paths, usually out and back, while the base vehicle can take a transverse path together with the satellite vehicles.

In practice, both the base vehicle and the satellite vehicle are supplied with power via electrical cables. These can be cables on reels or spiral cables, or the power supply is provided via lines from which the vehicles are supplied via slide contacts, and the lines can also be the rails themselves. This means a great deal of electrical installation work, especially if there are numerous transfer routes. Alternatively nowadays, the satellite vehicles are supplied with electrical power via a cable from the base trolley. This means that the base vehicle must always be within “range” of the satellite vehicle and is not available for other tasks.

It is therefore the object of the invention to make the base vehicle and the satellite vehicle more independent of each other.

The object is attained by the features of claim 1 and in particular by the fact that the satellite-vehicle electric motor can be supplied via an energy store connected to the satellite vehicle and that the energy store can be charged by a charging station carried on the base vehicle.

The invention ensures that the satellite vehicles can charge the energy store on the base vehicle. This makes them completely independent of the base vehicle or other electrical lines for supplying the drive motor in terms of their electric drive. The charging takes place efficiently when the satellite vehicle is resting on the base vehicle.

While the satellite vehicle performs tasks on a transfer path, such as depositing or picking up a stack of construction boards, the base vehicle can, for example, take another satellite vehicle to another location or pick it up from another location, e.g. another transfer path. The satellite vehicle rests on the base vehicle and is transported by it at the same time. In its rest or transport position on the base vehicle, the satellite vehicle is electrically connected to the charging station. The connection is preferably activated automatically.

Preferably, there are at least two charging stations for one satellite vehicle each on the base vehicle.

Two home spaces have the advantage that the satellite vehicles can either be used alternatively or, in the case of particularly large base areas of the construction board stacks, two satellite vehicles can be used in parallel.

The complete decoupling of the satellite vehicles from the base vehicles can be achieved in an advantageous way by at least one satellite vehicle being controllable via radio, WLAN or Bluetooth signals.

This also eliminates the signal or data lines previously used between the two vehicles, so that there is no longer any cable connection between the base vehicle and the satellite vehicle in the positively designed version, i.e. neither for the power supply nor for control.

In the event that a satellite vehicle remains at one of the transfer paths for a longer period of time, it is preferable if at least one additional charging station for the energy store of a satellite vehicle is located in the transfer path.

Further advantageous embodiments of the storage system can be found in further sub-claims.

It therefore makes sense for each satellite vehicle to have a lifting/lowering device for at least one construction board. As a rule, however, this will actually be a tall stack of construction boards. In this case, the satellite vehicle should be able to carry at least 50 stacked construction boards, preferably even 100. If the construction boards are larger, two satellite vehicles can also be moved in parallel next to each other on the transfer paths and these two can carry the stacks in parallel and together,

In a simple manner and preferably, each lifting/lowering device can lift the construction board or the stack of construction boards above the height level of a board-storage location. The board-storage location is preferably formed from at least two spaced, horizontally extending beams. The transfer path for the satellite vehicle is ideally located exactly between two beams. If two satellite vehicles traveling in parallel are required to transport the stack of construction boards, three parallel beams should be provided as a board-storage location. In this case, the transfer paths for the two satellite vehicles are arranged in the two intermediate spaces for deposition there. Conversely, a stack of construction boards can be picked up from the board-storage location by lifting it above the board-storage location using the lifting/lowering device and transporting it away. The satellite vehicle can then drive up to the base vehicle with the lifted stack of construction boards.

The lifting/lowering device can be operated hydraulically (hydraulic cylinders supplied by an electric pump) or by an electric motor (via a spindle-gear transmission). It consists of the actuator that can be raised and lowered and a support for the construction board or the stack of construction boards. The energy required for the movement can also be taken from the rechargeable energy store.

In the following, the invention is described in more detail with reference to drawings illustrating embodiments. Therein:

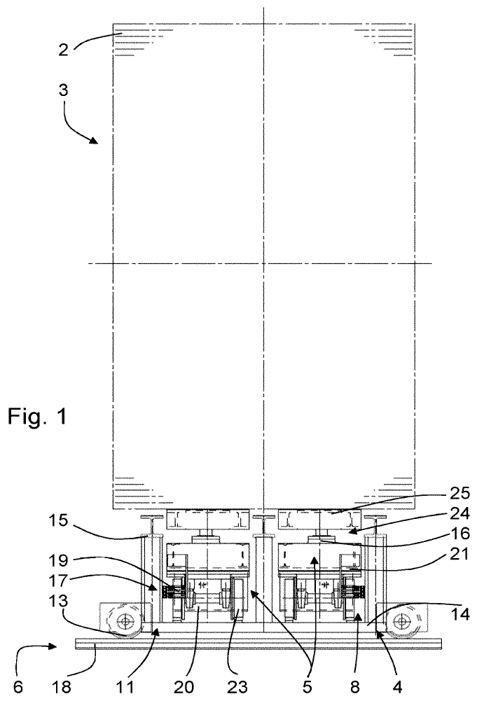

FIG. 1 is a side view of an embodiment of a base vehicle with two satellite vehicles having a home space according to the invention,

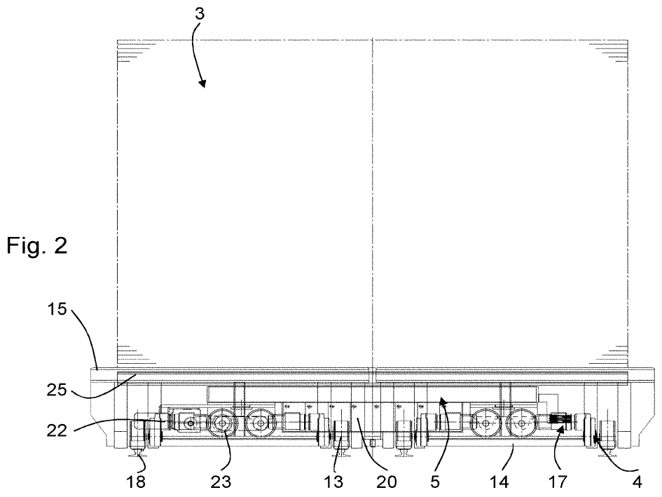

FIG. 2 is a front view of the base vehicle of FIG. 1,

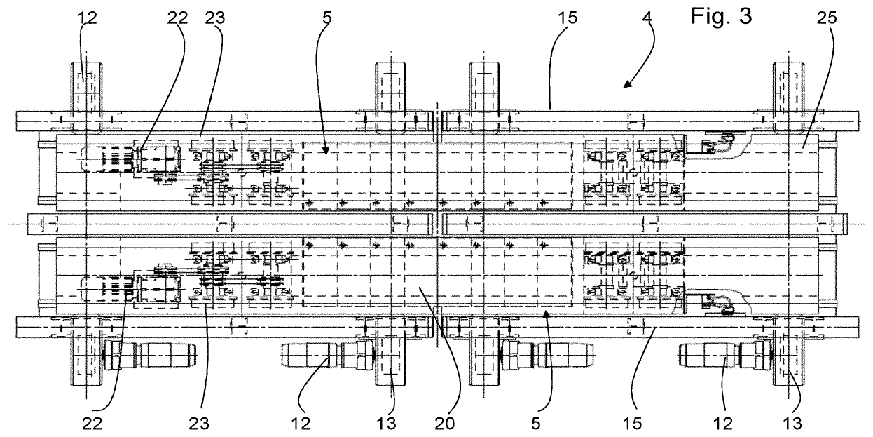

FIG. 3 is a top view of the base vehicle according to the invention,

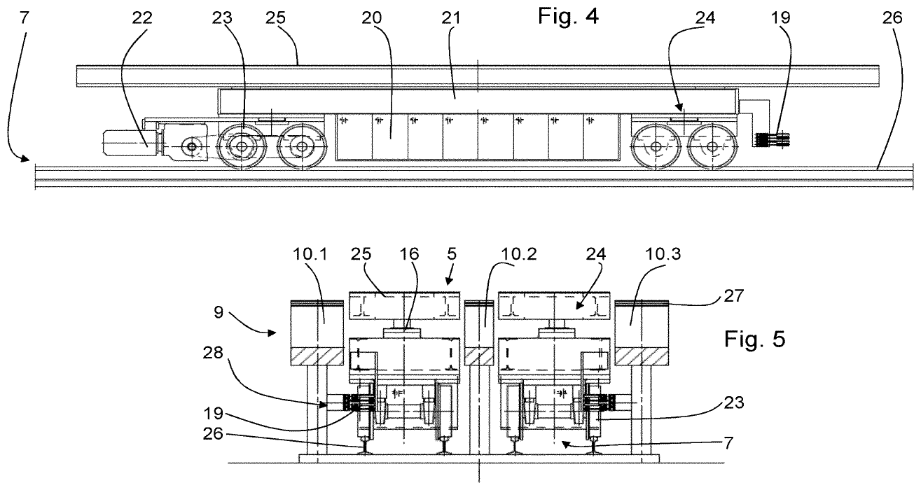

FIG. 4 is a side view of one of the satellite vehicles according to the invention,

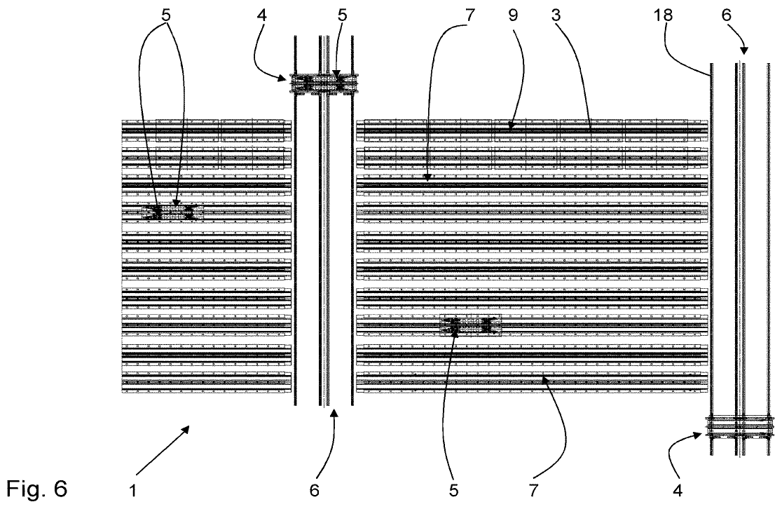

FIG. 5 shows two satellite vehicles in the storage system according to the invention, and

FIG. 6 is an exemplary overall top view of a storage system according to the invention.

The drawing shows the same embodiment of a storage system or components thereof. FIGS. 1 to 3 primarily show the base vehicle from three different perspectives, FIGS. 4 and 5 show the satellite vehicle and FIG. 6 provides an overview of the entire storage system 1 according to the invention.

FIGS. 1 to 3 therefore show the base vehicle 4 that can move on so-called base travel paths 6. The base travel paths 6 have rails 18 for the base vehicle 4, whose eight wheels 13 in this embodiment are partially driven by respective base-vehicle electric motors 12. These base-vehicle electric motors 12 are supplied with power that the base vehicle 4 draws via slide contacts on or next to the rails.

Two satellite vehicles are positioned on two home spaces 8 above the floor plate 14 of the chassis 11 of the base vehicle 4 that can be sent on travel paths transversely to the base travel path. The satellite vehicles each also have eight wheels 23, some of which are driven by respective satellite-vehicle electric motors 22. However, these satellite-vehicle electric motors 22 do not obtain their power via a cable connection between the respective satellite vehicle 5 and the base vehicle 4 or another source, but are supplied via rechargeable energy stores 20. The necessary charging stations 17 are on the base vehicle 4. Contacts 19 on the satellite vehicle 5 are automatically connected to one of the charging stations 17 when the satellite vehicle 5 is in its home space 8. When the satellite vehicle or the satellite vehicles 5 are on the transfer path 7 they are then completely independent of the base vehicle and can, for example, travel to another transfer path 7 and join other satellite vehicles 5 there. It is also envisaged that each satellite vehicle 5 can be controlled via radio, WLAN or Bluetooth signals.

The satellite vehicles 5 are each capable of carrying one or two very large stacks of construction boards 3, for example, and transporting them onto the base vehicle 4. The construction boards 2 lie on respective construction-board supports 25 that, together with an actuator 16, for example a hydraulic cylinder, forms a lifting/lowering device 24 with which the stacks of construction boards 3 can be set on supports 15 of the base vehicle 4. The energy requirement of this lifting/lowering device 24 can also be obtained from the energy store 20.

FIG. 1 and FIG. 2 show the lifting/lowering device 24 respectively in a raised state and in a lowered state, so that in FIG. 1 the construction board stack is still supported by the construction board support 25 and in FIG. 2 by the supports 15.

FIG. 3 shows in particular the positions of the motors 12 and 22 and the wheels 13 and 23 of both vehicles 4 and 5 in plan view.

FIGS. 4 and 5 illustrate the satellite vehicle. The satellite vehicles 5 also travel on rails 26 in this embodiment on the transfer paths 7. They each have a chassis 21, above which the construction board support 25 is mounted by the respective actuator 16. Two wheels 23 per rail 26 are provided at both ends in the direction of travel, driven by respective satellite-vehicle electric motors 22 also provided at one end. A number of energy stores 20, for example rechargeable electric batteries, are located therebetween that can be charged via the electrical contacts 19. As FIG. 5 shows, charging stations 28 can also be provided on the transfer paths.

FIG. 5 shows two satellite vehicles 5 traveling in parallel on the rails 26. They each move between horizontal and parallel supports 10.1, 10.2 and 10.3 that form numerous board supports. The stacks of boards 3 can be deposited there, preferably on elastic elements 27. During transportation of the stacks of construction boards 3 by the satellite vehicles 5, the construction board support 25 is initially raised to a level above the elastic supports 27. At the board-storage location 9, the stacks of construction boards 3 can be lowered by of the lifting/lowering device 24 and placed on the supports. FIG. 5 shows two satellite vehicles 5 moving in parallel, because sometimes the material sheets 2 are so long that they must be carried by two satellite vehicles 5. It should also be ensured that the satellite vehicle can preferably carry 100 construction boards.

Finally, FIG. 6 is a top view of an embodiment of a complete storage facility 1. Two base travel paths 6 with rails 18 can be seen. One extends straight transversely through the middle of the transfer travel paths 7. The other runs along the edge. A base vehicle 4 can be seen on both, with the base vehicle 4 on the left carrying two satellite vehicles 5, each on a home space 8, while the base vehicle 4 on the right is empty. Two pairs of satellite vehicles 5 are currently on transfer paths 7. Precise details are not recognizable due to the large reduction in size of the drawing. Stacks of construction boards 3 are on occupied board-storage locations 9 indicated by small boxes. However, the boxes can already have dimensions of 2000 mm to 3200 mm in width and 5000 mm to 10,000 mm in length. With a stacking height of up to 5 meters, however, the current design should not exceed 60 tons in weight.

List of reference symbols

| | |
|---|---|
| 1 | Storage facility |
| 2 | Construction boards |
| 3 | Construction-board stack |
| 4 | Base vehicle |
| 5 | Satellite vehicle |
| 6 | Base travel path |
| 7 | Transfer path |
| 8 | Home space |
| 9 | Board-storage location |
| 10.1, 10.2, 10.3 | Beam |
| 11 | Base-vehicle chassis |
| 12 | Base-vehicle drive motor |
| 13 | Base-vehicle wheel |
| 14 | Base plate |
| 15 | Base vehicle support |
| 16 | Hydraulic cylinder, actuator |
| 17 | Base vehicle charging station |
| 18 | Base-vehicle rail |
| 19 | Contacts |
| 20 | Energy store |
| 21 | Satellite-vehicle chassis |
| 22 | Satellite-vehicle drive motor |
| 23 | Satellite-vehicle wheel |
| 24 | Lifting/lowering device |
| | satellite vehicle |
| 25 | Satellite-vehicle |
| | construction-board support |
| 26 | Satellite-vehicle rail |
| 27 | Elastic support |
| 28 | Transfer-path charging |
| | station |

1. A storage system for construction boards comprising a rail-type base travel path and at least one base vehicle movable thereon as well as several transfer paths leading to board-storage locations and at least one satellite vehicle movable thereon that is capable of moving at least one construction board, wherein
a home space is provided on the base vehicle for the at least one satellite vehicle,
the base vehicle has an electrical power supply, for example via a slide contact, and a drive with a base-vehicle electric motor, and
the satellite vehicle also has a drive with a satellite-vehicle electric motor,
characterized in that
the satellite-vehicle electric motor of the satellite vehicle can be powered from an energy store connected to the satellite vehicle and the energy store can be charged from a charging station on the base vehicle.

2. The storage system according to claim 1, wherein at least two charging stations for one satellite vehicle are each provided on the base vehicle.

3. The storage system according to claim 1, wherein the satellite vehicle can be controlled via radio, WLAN or Bluetooth signals.

4. The storage system according to claim 3, wherein there is no cable connection between the base vehicle and the satellite vehicle.

5. The storage system according to claim 1, wherein at least one further charging station for the energy store of the satellite vehicle is located in a transfer path.

6. The storage system according to claim 1, wherein two satellite vehicles can be moved in parallel next to each other on the transfer paths.

7. The storage system according to characterized claim 1, wherein one satellite vehicle or two satellite vehicles moving in parallel next to each other carry a stack of at least 50 construction boards.

8. The storage system according to claim 1, wherein each satellite vehicle has a lifting/lowering device for at least one construction board.

9. The storage system according to claim 1, wherein each board storage location is formed by at least two horizontally extending beams.

10. The storage system according to claim 9, wherein a transfer path extends between two beams.
